(19) United States
(12) Patent Application Publication
(10) Pub. No.: US 2002/0158043 A1
(43) Pub. Date: Oct. 31, 2002

(54) Method of fabricating a flexible circuit board

(76) Inventors: Yi-Jing Leu, Hsinchu (TW); Chih-Ching Chen, Taipei (TW); Ming-Chung Peng, Hsinchu (TW)

Correspondence Address: RABIN & BERDO, P.C., Suite 500, 1101 14th Street, N.W., Washington, DC, 20005, US

(21) Appl. No.: 10/127,412

(22) Filed: Apr. 23, 2002

(30) Foreign Application Priority Data
Apr. 27, 2001 (TW) 90110225

(51) Int. Cl. H01B 13/00

(52) U.S. Cl. 216/13

(57) ABSTRACT

An improved and simplified process of forming a flexible circuit board for ink jetting is disclosed. The method includes the steps of: providing a substrate, wherein the substrate comprises a first surface and a second surface opposite to the first surface and the first surface is for forming conductive traces; and burning the substrate, by using laser-ablation, to form a plurality of contact holes which expose the conductive traces. The above-mentioned method further comprises the steps of sputtering a copper film on the first surface of the substrate; forming a photo-resistor layer over the copper film, wherein a pattern of the photo-resistor layer is complementary to the conductive traces and a portion of the copper film is exposed; plating a copper layer over the exposed portion of the copper film as the conductive traces; removing the photo-resistor layer; and burning the insulation tape to form the contact holes, using laser-ablation.

This application incorporates by reference of Taiwan application Serial No. 90110225, filed Apr. 27, 2001.

### BACKGROUND OF THE INVENTION

1. Field of the Invention

The invention relates in general to a method of fabricating a flexible circuit board, and more particularly to a method of fabricating a flexible circuit board by using laser-ablation.

2. Description of the Related Art

Flexible circuit boards used in the cartridge of an ink-jet printer serve as medium to lead the driving current to the chip for ink jetting. The driving current drives the cartridge and enables the cartridge to jet ink.

Polyimide (PI) is a typical substrate for the conventional flexible circuit board. Copper (Cu) and gold (Au) are two widely used materials for the conductive traces in the flexible circuit board. The dimples of the printer circuit contact the conductive traces through holes formed by tape automated bonding (TAB).

Etching and punching are two typical TAB manufacturing processes. Etching process is characterized by etching the tape while the punching process is characterized by punching the tape to form the holes.

FIGS. 1A-1J illustrate the conventional etching process. On the substrate 102, such as polyimide (PI), a copper film 104 with a thickness of about 100 Å is formed by sputtering. On the bottom side of the substrate 102 and over the copper film 104, photo-resistors (PR) 106 are formed. After exposing and developing the PRs 106, the patterns of the holes and the conductive traces are defined. Next, as shown in FIG. 1F, on the side of substrate 102 with the exposed copper film 104, a copper layer 108 with several μm is plated. Then, as shown is FIG. 1G, the substrate 102 is etched to form holes 110 at the bottom side. The photo-resistors at both sides are then removed, as shown in FIG. 1H. Then, as shown in FIG. 1I, by a photolithography process, including steps of forming a photo-resister layer, exposing, developing and etching, the copper film 104 not covered by the copper layer 108 is removed. Finally, as shown in FIG. 1J, an insulation layer 112 is formed over the copper layer 108 for the purpose of protection.

The conventional etching process has the following drawbacks: time consuming, producing thick and sticky precipitate and large amount of wastewater, high cost and low yield rate.

FIGS. 2A to 2I show the conventional punching method to form holes on an insulation layer.

As shown in FIGS. 2A and 2B, an adhesive layer 204 is coated on the substrate 202. Then, the substrate 202 coated with the adhesive layer 204 is punched to form holes 206. Next, a copper layer 208 is adhered over the substrate 202 coated with the adhesive layer 204. Then, as shown in FIGS. 2E to 2H, a photo-resistor layer 210 is formed on the copper layer 208. After the photolithography process, including exposing, developing and etching, the pattern of the copper layer 208 is defined. Finally, as shown in FIG. 21, an insulation adhesive layer 212 is formed on one side of the copper layer 208 for the purpose of protection.

Compared with the etching process as mentioned before, this punching process is shorter in procedure, produces much less wastewater and cost lower. However, the intervals between each two holes are large and hard to reduce. So that, less holes can be formed in the same area, which therefore influences the precision contact between the printer and the TAB. Further more, the punching step could easily cause the breakage of the substrate and thus reduce the yield rate and increase the cost.

### SUMMARY OF THE INVENTION

It is therefore an object of the invention to provide a method of fabricating a flexible circuit board without having the problems of producing contaminating developer but with the advantages of shorter and simplified procedure, lower cost, high hole resolution, and high yield rate.

An improved and simplified process of forming a flexible circuit board for ink jetting comprises the steps of: providing a substrate, wherein the substrate comprises a first surface and a second surface opposite to the first surface and the first surface is for forming conductive traces; and burning the substrate, by using laser-ablation, to form a plurality of contact holes which expose the conductive traces. The above-mentioned method further comprises the steps of sputtering a copper film on the first surface of the substrate; forming a photo-resistor layer over the copper film, wherein a pattern of the photo-resistor layer is complementary to the conductive traces and a portion of the copper film is exposed; plating a copper layer over the exposed portion of the copper film as the conductive traces; removing the photo-resistor layer; and burning the insulation tape to form the contact holes, using laser-ablation. Further more, the above-mentioned method can comprise the following steps: forming an adhesive layer on the first surface of the substrate; forming the contact holes, using laser-ablation; adhering a copper layer on the adhesive layer; and defining the copper layer to form the conductive traces by photolithography. The material of the substrate can be polymer such as polyimide, Teflon, polyamide, polymethylmethacrylate, polycarbonate, polyester, polyamide polyethylene-terephthalate copolymer, or any combination of the above materials.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A to 1J (Prior Art) illustrate the conventional etching process.

FIGS. 2A to 2I (Prior Art) show the conventional punching method to form holes on an insulation layer.

FIG. 3 shows a single point laser beaming system.

FIG. 4 shows a multi-point laser beaming system.

FIGS. 5A to 5J illustrate the process of fabricating contact holes on the insulation tape by laser-ablation according to a preferred embodiment of the invention.

FIGS. 6A to 6I illustrate the process of fabricating contact holes on the insulation tape by laser-ablation according to another preferred embodiment of the invention.

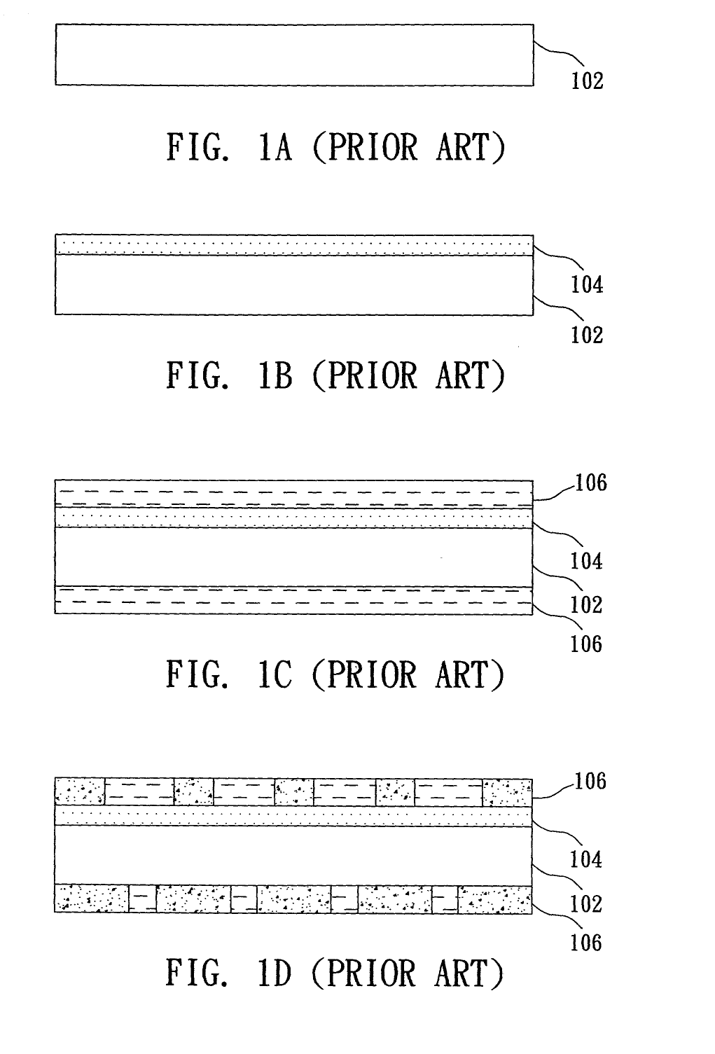

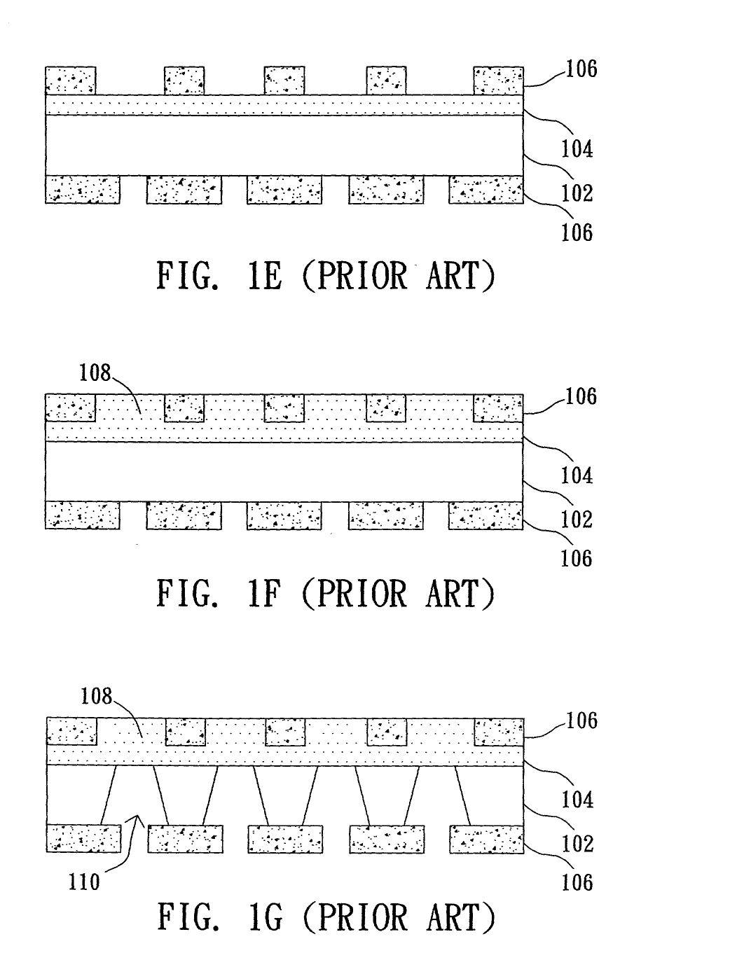

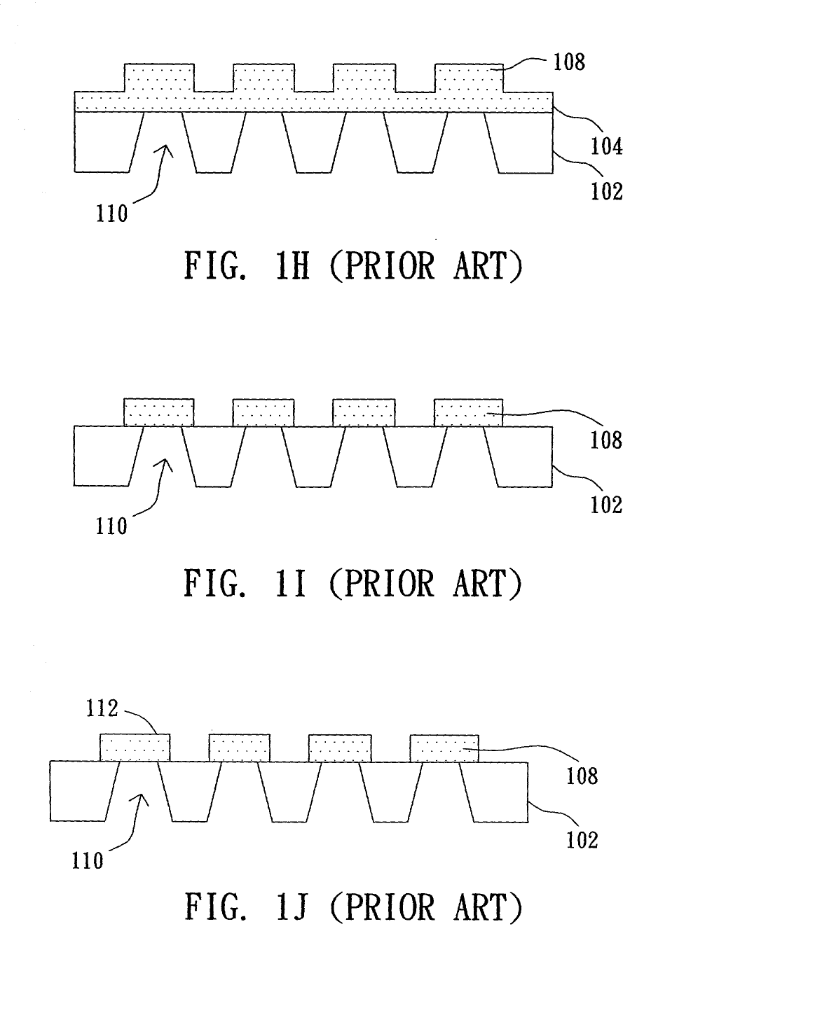

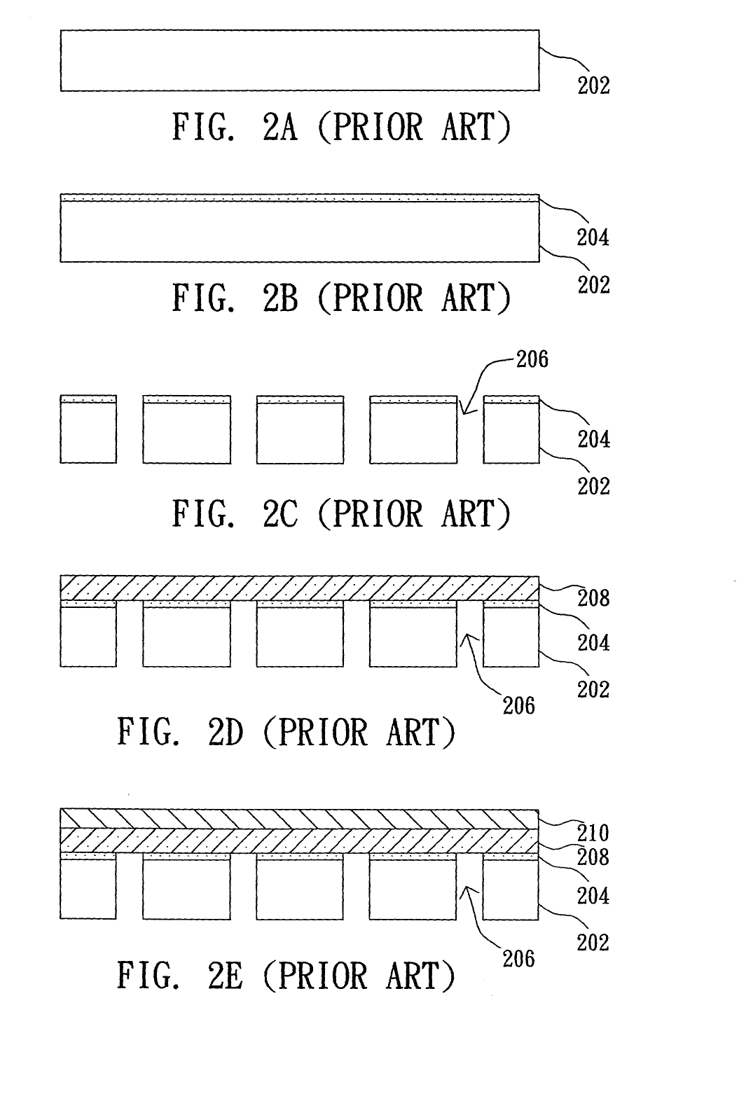

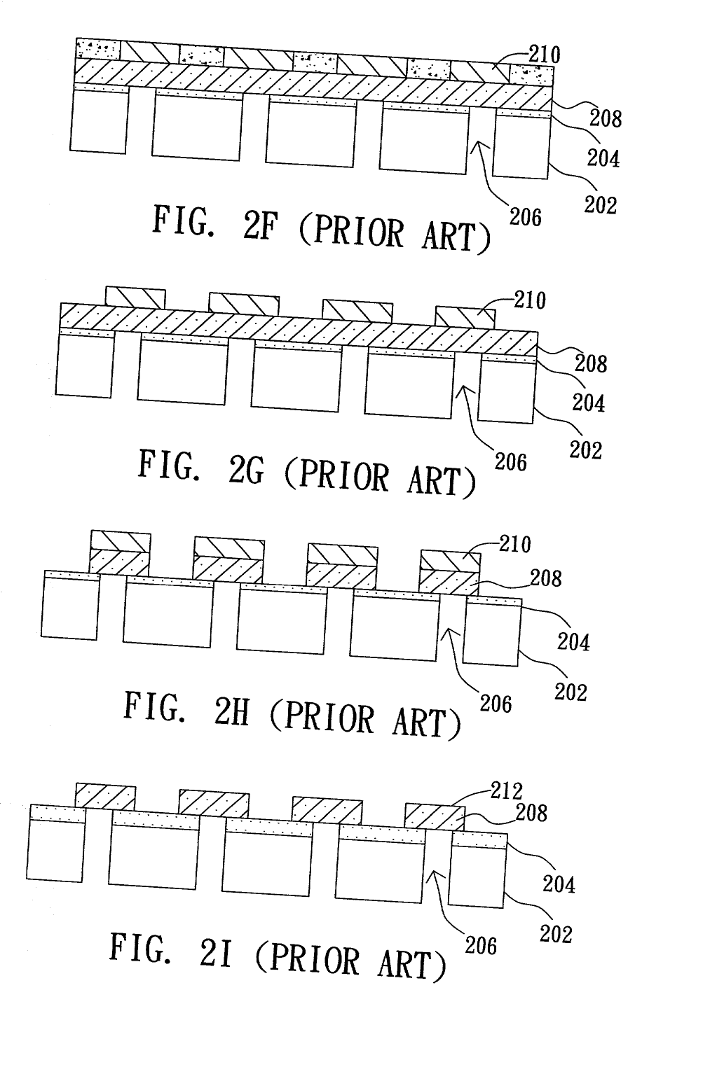

### DETAILED DESCRIPTION OF THE INVENTION

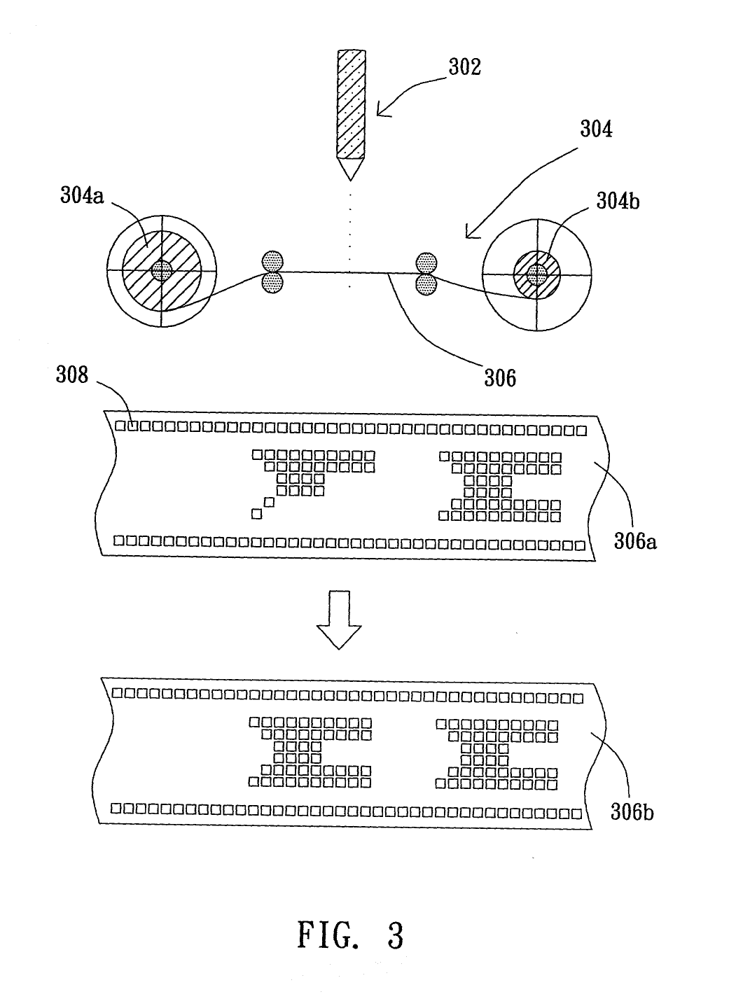

FIG. 3 shows a single point laser beaming system, mainly including a laser system 302 and a transmission system 304.

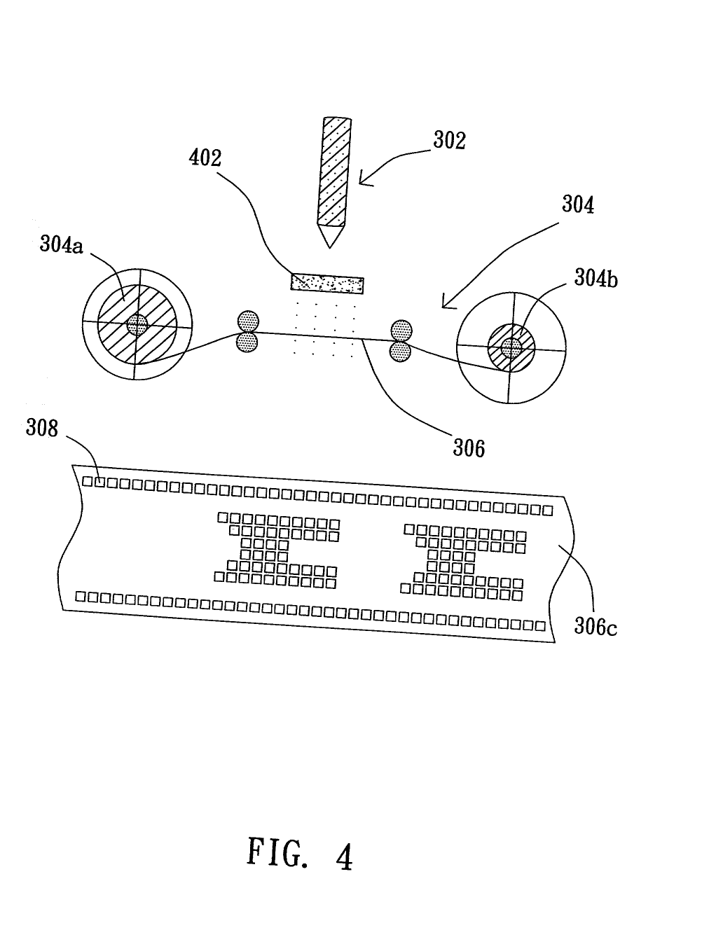

The laser system 302 includes a beam delivery optics, an alignment optics, a high-precision and high speed mask shuttle system (not shown) and precision lens used for focusing, positioned between an insulation tape 306 and a mask (please refer to FIG. 4), are used for focusing.

The transmission system 304 includes a reel 304a and a take-up reel 304b. The sprocket holes 308 on the insulation tape 306 benefits the insulation tape 306 to be driven by the reel 304a and the take-up reel 304b more smoothly. Number 306a indicates an original insulation tape and the insulation tape 306b is one examples of the insulation tape 306a after the contact holes are formed by burning.

The laser-ablation used in the invention can be an excimer laser or CO₂ laser. The excimer laser is laser radiation produced by F₂, ArF, KrCl, KrF or XeCl.

In addition to the single point laser beaming system as shown in FIG. 3, the multi-point laser beaming system as shown in FIG. 4 can be also applied to produce contact holes on the flexible circuit board for dimples of printer to contact. The multi-point laser beaming system as shown in FIG. 4 can be the combination of the single point laser beaming system as shown in FIG. 3 and a mask 402. The mask 402 has a pattern of the desired holes and is positioned between the insulation tape 306 and the laser system 302. The mask 402 is preferably made of a high laser reflection rate material with a multilayer dielectric or metal such as aluminum on it.

Generally, soot produced by laser-ablation can distribute to a distance up to 1 cm. Thus, if the mask 402 is positioned close to the insulation tape 306c, soot could spread onto the mask 402 and burn the mask 402, which consequently deforms the pattern of the hole and further influences the precision. Using an appropriate mask, such as a projection mask, and positioning the mask 402 away from the insulation tape 306 for at least 2 cm can avoid the burning of the mask 402.

The following examples are taken to explain the process of fabricating contact holes on the flexible circuit board.

### EXAMPLE 1

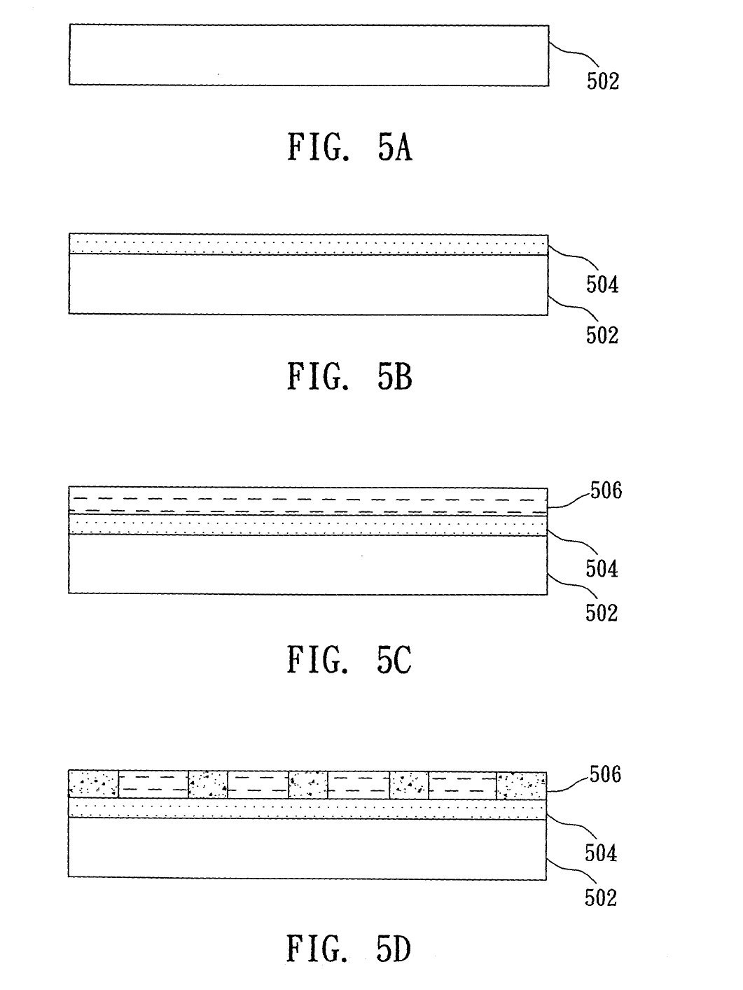

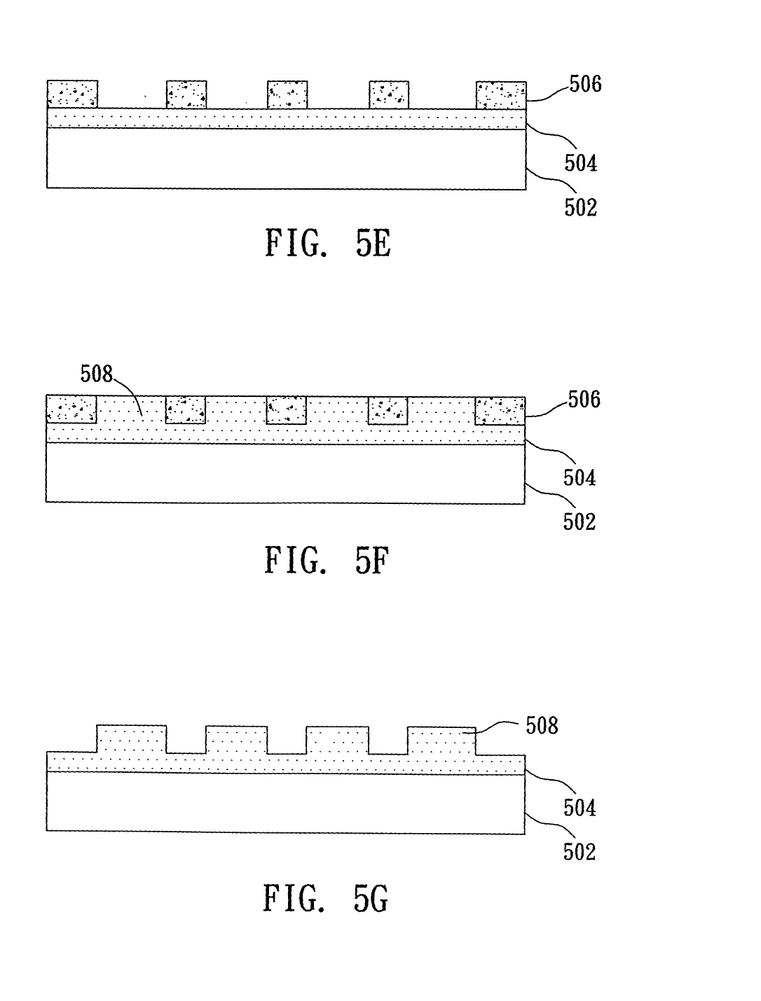

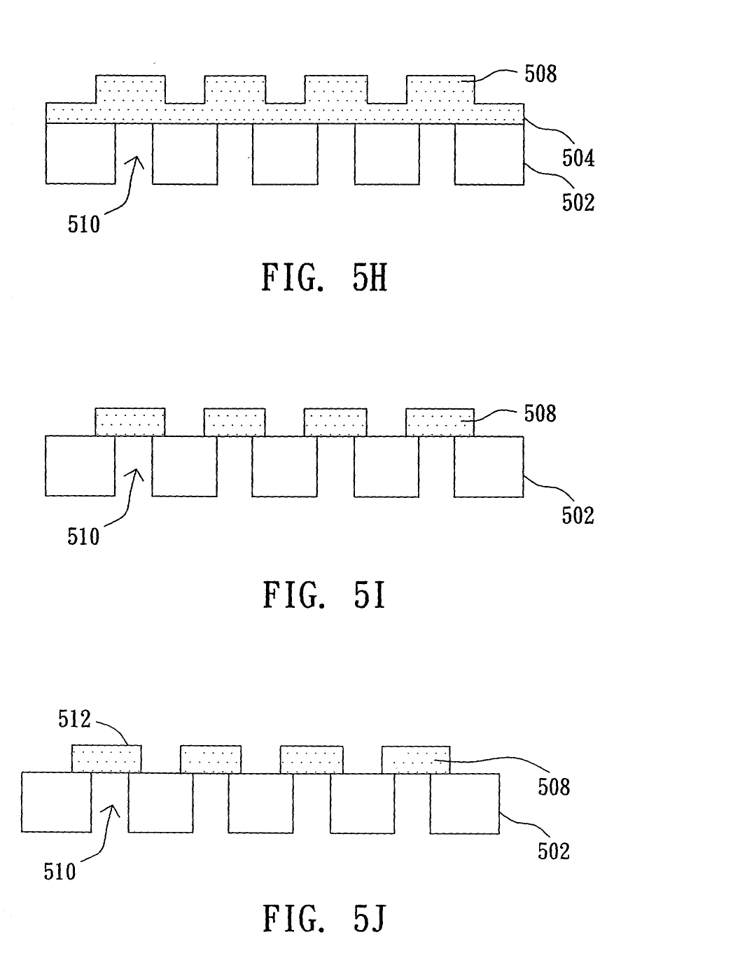

Referring to FIGS. 5A to 5J, the process of fabricating contact holes on the insulation tape 502 by laser-ablation according to a preferred embodiment of the invention is illustrated. First, as shown in FIG. 5A and FIG. 5B, on the substrate, such as the insulation tape 502, preferably made of polyimide (PI), a copper film 504 with a thickness of about 100 Å is sputtered. As shown in FIGS. 5C, 5D and 5E, a photo-resistor layer 506 is formed on the copper film 504. A pattern complementary to the desired conductive traces is formed after the steps of exposing and developing.

Then, referring to FIG. 5F, a copper layer 508 with several μm is plated on the exposed copper film 504. As shown in FIG. 5G and FIG. 5H, after the photo-resistor layer 506 is removed, contact holes 510 are burned on the insulation tape 502 by laser-ablation as described above, whereas the copper film 504 and the copper layer 508 can be used as a laser-ablation ending layer. The excimer laser or the CO₂ laser can be applied to burn the insulation tape 502. Also, single point laser beaming system and multi-point laser beaming system are two alternative ways. Then, as shown in FIG. 51, by a photolithography process, including forming a photo-resistor layer, exposing, developing and etching, the copper film 504 uncovered by the copper layer 508 is removed. Then, as shown in FIG. 5J, an insulation adhesive layer 512 is formed on the copper layer 508 for the purpose of protection.

Besides polyimide (PI), the material of the insulation tape 502 can be other polymer film such as Teflon, polyamide, polymethylmethacrylate, polycarbonate, polyester, polyamide polyethylene-terephthalate copolymer, or any combination of the above materials.

In the example 1, the step of laser-ablation is performed after the step of plating of the copper layer 508 and the removal of the photo-resistor 506 and before the removal of the exposed copper film 504. However, the invention is not limited hereto. Instead, the step of laser-ablation can be performed at any other suitable stage, such as after the step of sputtering of the copper film 504 or after the steps of formation of copper layer 508 and the insulation adhesive layer 512.

### EXAMPLE 2

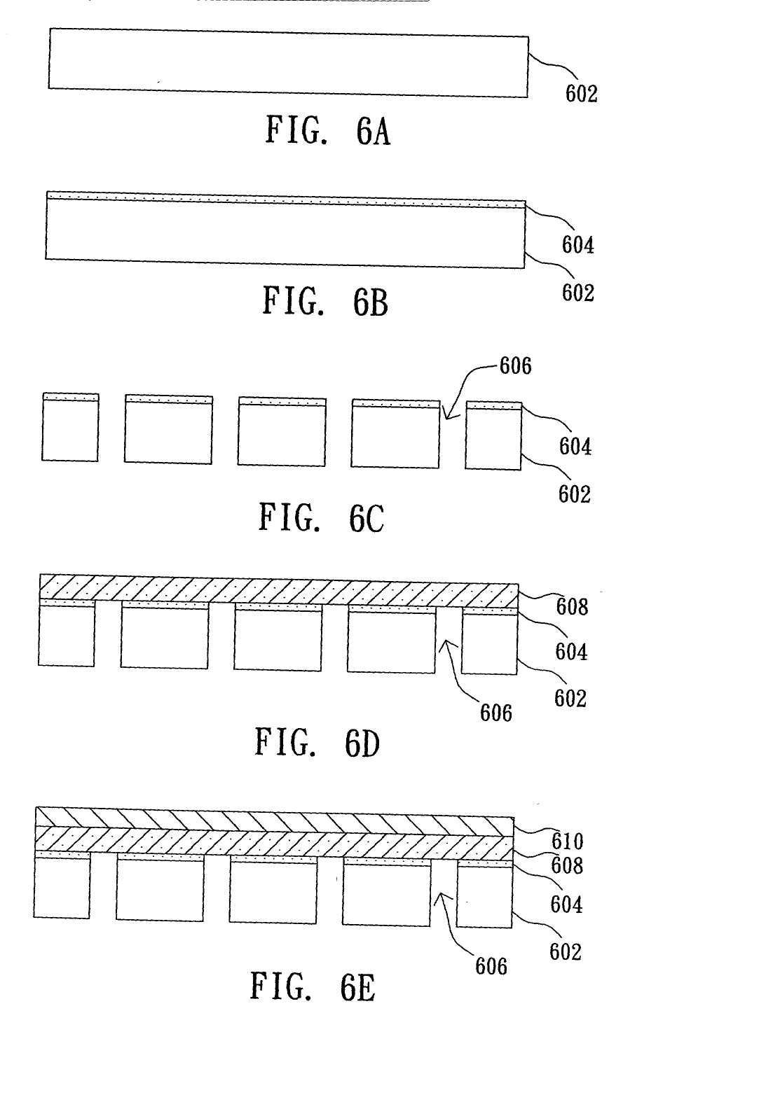

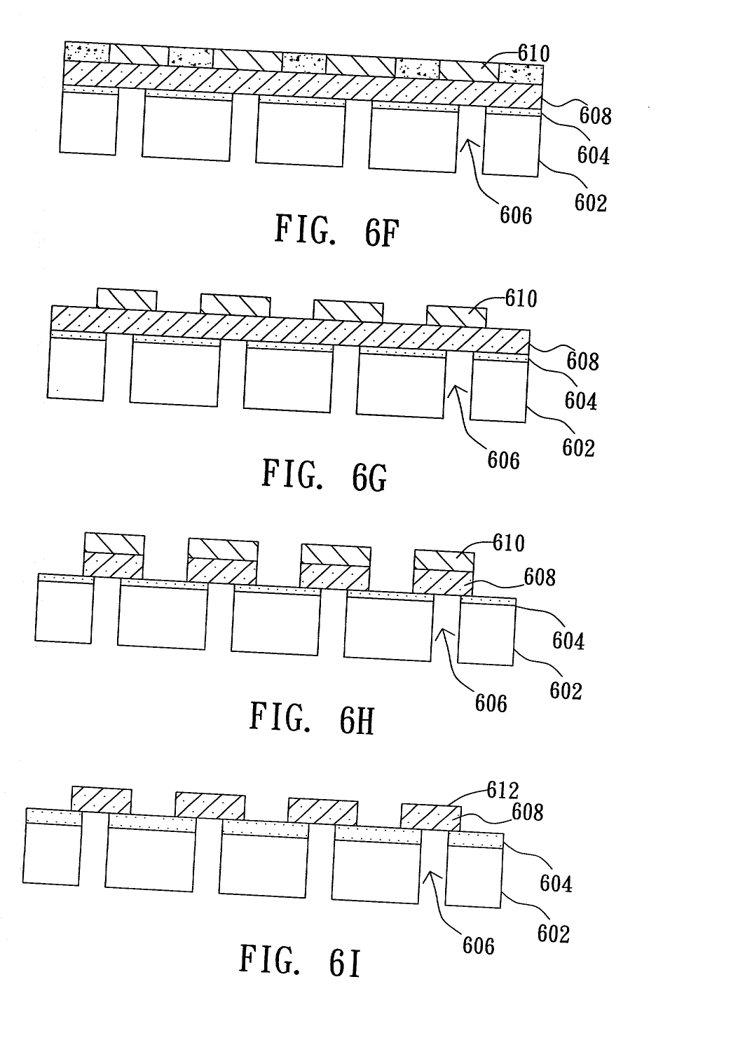

Referring to FIGS. 6A to 6J, the process of fabricating contact holes on the insulation tape 602 by laser-ablation according to another preferred embodiment of the invention is illustrated.

First, as shown in FIG. 6A and FIG. 6B, on the substrate, such as an insulation tape 602, an adhesive layer 604 is coated. Next, referring to FIG. 6C and FIG. 6D, contact holes 606 are burned on the insulation tape 602 by laser-ablation as described above. The excimer laser or the CO₂ laser can be applied to burn the insulation tape 602. Also, single point laser beaming system and multi-point laser beaming system are two alternative ways. Then, a copper layer 608 is adhered on the insulation tape 602 with the aid of the adhesive layer 604. Next, as shown in FIG. 6E to FIG. 6H, the pattern of the copper layer 608 is defined by a photolithography process, including forming a photo-resistor layer 610, exposing, developing and etching. Finally, as shown in FIG. 6I, the photo-resistor layer 610 is removed and an insulation adhesive layer 612 is formed over the copper layer 608 for the purpose of protection.

Besides polyimide (PI), the material of the insulation tape 602 can be other polymer film such as Teflon, polyamide, polymethylmethacrylate, polycarbonate, polyester, polyamide polyethylene-terephthalate copolymer, or any combination of the above materials.

In the example 2, the step of laser-ablation is performed before the step of adhering the copper layer 608. However, the invention is not limited hereto. Instead, the step of laser-ablation can be performed at any other suitable stage, such as after the step of formation of the pattern of the copper layer 608, using the copper layer 608 as a laser-ablation ending layer.

Forming contact holes on the insulation tape according to the preferred embodiment of the invention has the advantages of: shortened and simplified manufacturing process, lower cost, producing less wastewater, high contact holes resolution, and high yield rate (up to 99%).

While the invention has been described by way of an example of manufacturing a flexible circuit board (FCB), it is to be understood TAB device is also within the scope of the invention since FCB is commonly bounded with the chip through a TAB process.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of forming a flexible circuit board, comprising the steps of:
providing a substrate, wherein the substrate comprises a first surface and a second surface opposite to the first surface and the first surface is for forming conductive traces; and
burning the substrate, by using laser-ablation, to form a plurality of contact holes which expose the conductive traces.

2. The method according to claim 1, wherein the substrate is an insulation tape.

3. The method according to claim 2, wherein the insulation tape comprises a polymer film.

4. The method according to claim 3, wherein the material of the polymer film comprising at least one of polyimide (PI), Teflon, polyamide, polymethyl methacrylate, polycarbonate, polyester, and polyamide polyethylene-terephthalate copolymer.

5. The method according to claim 3, wherein the material of the polymer film is polyimide (PI).

6. The method according to claim 1, further comprising the steps of:
sputtering a copper film on the first surface of the substrate;
forming a photo-resistor layer over the copper film, wherein a pattern of the photo-resistor layer is complementary to the conductive traces and a portion of the copper film is exposed;
plating a copper layer over the exposed portion of the copper film as the conductive traces;
removing the photo-resistor layer; and
burning the substrate to form the contact holes, using laser-ablation.

7. The method according to claim 1, further comprising the following steps:
forming an adhesive layer on the first surface of the substrate;
forming the contact holes, using laser-ablation;
adhering a copper layer on the adhesive layer; and
defining the copper layer to form the conductive traces by photolithography.

8. The method according to claim 1, wherein excimer laser is applied in the laser-ablation.

9. The method according to claim 8, wherein the excimer laser method is laser radiation produced by F₂, ArF, KrCl, KrF or XeCl.

10. The method according to claim 1, wherein CO₂ laser is applied in the laser-ablation.

11. The method according to claim 1, wherein a single point laser beaming system is applied in the laser-ablation.

12. The method according to claim 1, wherein a multi-point laser beaming system is applied in the laser-ablation.

13. The method according to claim 12, wherein a projection mask is applied.

14. The method according to claim 13, wherein the projection mask is made of a high laser reflection rate material covered by a multilayer dielectric.

15. The method according to claim 13, wherein the projection mask is made of a high laser reflection rate material covered by aluminum.

16. A method of forming a flexible circuit board, comprising the steps of:
(a) providing a substrate, wherein the substrate comprises a first surface and a second surface opposite to the first surface and the first surface is for forming conductive traces;
(b) sputtering a copper film on the first surface of the substrate;
(c) forming a photo-resistor layer over the copper film, wherein a pattern of the photo-resistor layer is complementary to the conductive traces and a portion of the copper film is exposed;
(d) plating a copper layer over the exposed portion of the copper film as the conductive traces;
(e) removing the photo-resistor layer; and
(f) burning the insulation tape to form a plurality of contact holes which expose the conductive traces, using laser-ablation.

17. The method according to claim 16, wherein the step (f) can be moved after the step (b) and before the step (c).

18. A method of forming a flexible circuit board, comprising the steps of:
(a) providing a substrate, wherein the substrate comprises a first surface and a second surface opposite to the first surface and the first surface is for forming conductive traces;
(b) forming an adhesive layer on the first surface of the substrate;
(c) burning the insulation tape to form a plurality of contact holes, using laser-ablation;
(d) adhering a copper layer on the adhesive layer; and
(e) defining the copper layer to form the conductive traces by photolithography.

19. The method according to claim 18, wherein the step (c) can be moved between the step (d) and before the step (e).
